(19) United States
(12) Patent Application Publication
(10) Pub. No.: US 2026/0192259 A1
(43) Pub. Date: Jul. 9, 2026

(54) ZWITTERION ANTI-SCALING MEMBRANE COATINGS

(71) Applicant: Arizona Board of Regents on behalf of Arizona State University, Scottsdale, AZ (US)

(72) Inventors: Marylaura Lind Thomas, Scottsdale, AZ (US); Elisabeth Thomas, Tempe, AZ (US); Matthew Green, Phoenix, AZ (US); Jae Sang Lee, Tempe, AZ (US); Hoda Shokrollahzadeh Behbahani, Tempe, AZ (US)

(21) Appl. No.: 19/134,424

(22) PCT Filed: Dec. 4, 2023
(86) PCT No.: PCT/US2023/082347

§ 371 Date: May 30, 2025

Related U.S. Application Data
(60) Provisional application No. 63/429,881, filed on Dec. 2, 2022.

(51) Int. Cl. B01D 71/82; B01D 61/36; B01D 69/02; B01D 71/80; C02F 1/44; C08J 7/04; C08J 7/056; C09D 5/16; C09D 133/14; C09D 135/02

(52) U.S. Cl. CPC B01D 71/82; B01D 61/362; B01D 69/02; B01D 71/80; C02F 1/448; C08J 7/0427; C08J 7/056; C09D 5/1668; C09D 133/14; C09D 135/02; B01D 2325/18; B01D 2325/30; C02F 2303/22; C08J 2353/00; C08J 2433/14; C08J 2435/02

(57) ABSTRACT

A zwitterionic material includes a substrate including a first polymer, and a second polymer bonded to the first polymer. The second polymer includes a zwitterionic component. Making the zwitterionic material includes coating a polymerizable material on a substrate, and polymerizing the polymerizable material, thereby bonding a second polymer to the substrate, wherein the second polymer comprises the zwitterionic component. The substrate includes the first polymer, and the polymerizable material includes the zwitterionic component.

### CROSS-REFERENCE TO RELATED APPLICATION

This application claims the benefit of priority to U.S. Patent Application No. 63/429,881, filed on Dec. 2, 2022, which is incorporated herein by reference in its entirety.

### STATEMENT OF GOVERNMENT SUPPORT

This invention was made with government support under 1254215, 1449500, and 1836719 awarded by the National Science Foundation and under W911NF-15-1-0353 and W911NF-18-1-0412 awarded by the Army Research Office and under DE-EE0009274 awarded by the Department of Energy and under 80NSSC19K1178 awarded by the National Aeronautical & Space Administration. The government has certain rights in the invention.

### TECHNICAL FIELD

This invention generally relates to pervaporation membranes coated with zwitterions, their preparation, and their resistance to scaling when used as water filters.

### BACKGROUND

Pervaporation is a membrane process that utilizes dense, non-porous membranes to perform separations driven by a chemical potential difference. Pervaporation membranes are generally made from dense polymers or molecular sieving inorganic materials. Membrane materials may be relatively more hydrophilic or hydrophobic, depending on the solute of interest and desired separation in a system. Pervaporation operates via a difference in chemical potential between the feed and permeate sides of the membrane, often realized by applying a vacuum to or passing a sweep gas by the permeate side of the membrane, and then condensing the vapor in the permeate later in the process. One of the most advantageous aspects of pervaporation, compared to applied pressure driven processes such as reverse osmosis, is that pervaporation is not limited by the total dissolved solids (TDS) of the feed. Pervaporation has advantages over processes such as membrane distillation (MD) as well. MD utilizes porous membranes, which are subject to failure through wetting, where liquid solvent enters the pores of a membrane and destroy its ability to perform separation through convective gas flow. The dense nature of pervaporation membranes make them impervious to wetting and allows them to retain volatile organic compounds based on their solubility (or lack thereof) in the polymer. While highly contaminated feeds can still pose challenges, such as scaling or fouling, the pervaporation process has the potential of handling feeds with both organic and inorganic contaminants.

Scaling is a phenomenon in water treatment systems wherein inorganic species deposit onto the surface of the equipment or membranes which can cause systematic problems with performance. Fouling, similar to scaling, is when organic materials deposit in a system. In membrane systems, scaling frequently occurs on the surface of the membrane, which will gradually reduce flux and eventually cause the process to fail. Scaling can be initiated by precipitates forming in the bulk of the solution or at the membrane-feed interface.

The urine processing assembly (UPA) used on the International Space Station (ISS), often experiences scaling from the highly concentrated wastewaters. Generally, in water treatment processes, and specifically for NASA and the ISS, divalent ions (e.g., Ca²⁺ and Mg²⁺) are of particular concern because of the potential for scaling.

### SUMMARY

This disclosure describes methods to coat zwitterionic polymers onto the surface of pervaporation membranes to reduce scaling in water reclamation devices. Pervaporation membranes can be used to purify wastewaters but are prone to scaling, in which inorganic species deposit on the surface and reduce the effectiveness of the membrane. In order to mitigate the deposition of scaling species, pervaporation membranes are coated with zwitterions using a solvent-free copolymerization method in which a photoinitiator is used to initiate a free radical polymerization reaction between the zwitterion and a polymer on a membrane surface. The addition of the zwitterionic coating greatly improved the mechanical stability, hydrophilicity and anti-scaling properties of the membranes.

In a first general aspect, a zwitterionic material includes a substrate including a first polymer, and a second polymer bonded to the first polymer, wherein the second polymer includes a zwitterionic component.

Implementations of the first general aspect may include one or more of the following features.

In some cases, the first polymer includes a sulfonated block polymer. The substrate can be in the form of a membrane (e.g., a membrane having ordered microstructures). In one example, the membrane is a pervaporation membrane. The second polymer is typically in the form of a layer on a single side of the membrane. In some cases, the second polymer is in the form of a layer on two sides of the membrane.

In some implementations, the zwitterionic component includes [2-(methacryloyloxy)-ethyl]dimethyl-(3-sulfopropyl) ammonium hydroxide (DMAPS). In some implementations, the second polymer includes a diacrylate component (e.g., poly(ethylene glycol) diacrylate).

In a second general aspect, making a zwitterionic material includes coating a polymerizable material on a substrate, wherein the substrate comprises a first polymer and the polymerizable material comprises a zwitterionic component, and polymerizing the polymerizable material, thereby bonding a second polymer to the substrate, wherein the second polymer comprises the zwitterionic component.

Implementations of the second general aspect may include one or more of the following features.

In some cases, the first polymer includes a sulfonated block polymer. The substrate can be in the form of a membrane (e.g., a membrane having ordered microstructures). In one example, the membrane is a pervaporation membrane. Bonding the second polymer to the substrate can include forming a layer on a single side of the substrate. In some implementations, the zwitterionic component includes [2-(methacryloyloxy)-ethyl]dimethyl-(3-sulfopropyl)-ammonium hydroxide (DMAPS). In some implementations, the second polymer includes a diacrylate component (e.g., poly(ethylene glycol) diacrylate).

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 depicts a zwitterion coated membrane and accompanying hydration layer to provide anti-scaling properties to surface interfaces.

FIG. 2 shows polymer structures used in anti-scaling membrane development and a theoretical final structure of the coating polymer.

FIG. 3 shows attenuated total reflectance Fourier transform infrared (ATR-FTIR) spectra for Nexar™ as-received polymer and cast membranes in various states of processing.

FIG. 4 shows ATR-FTIR analysis of each constituent of the membrane synthesis process as well as the final coated membrane.

FIG. 5 shows contact angle values for UN (bare) and UZ (zwitterion coated) membrane samples in de-ionized water with representative images of each contact angle.

FIGS. 6A and 6B show scaling studies for both bare Nexar™ membranes and zwitterion coated membranes during passive 7-day experiments, with the membranes desiccated prior to final weight measurement. FIG. 6A shows un-sonicated membranes placed into scaling solutions directly after being cast. FIG. 6B shows membranes placed into scaling solutions after sonication.

### DETAILED DESCRIPTION

Methods for coating pervaporation membranes with zwitterions and the subsequent separation performance and scaling resistance properties of the coated membranes are described. Zwitterions are polymeric molecules that have covalently tethered positive and negative ions, but an overall neutral charge. Coating pervaporation membranes with zwitterions can increase the hydrophilicity of the membrane, which can facilitate the adsorption of a hydration layer of water molecules on the surface of the membrane and either slow or mitigate scalant nucleation.

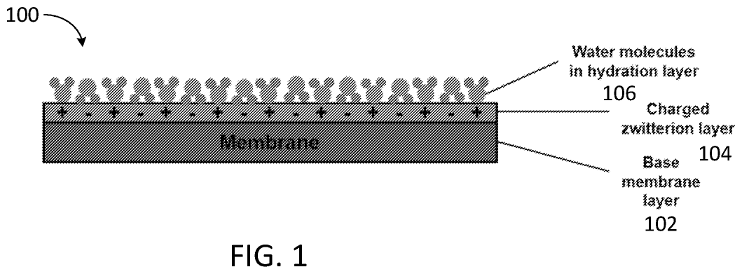

FIG. 1 depicts a zwitterion coated membrane 100 with base membrane layer 102, zwitterion layer 104, and water molecules in hydration layer 106. As described herein, hydration layer 106 provides anti-scaling properties to surface interfaces. Base membrane layer 102 is a pervaporation membrane and includes a first polymer with ordered microstructures. The first polymer is typically a sulfonated hydrocarbon block copolymer (e.g., with aromatic and aliphatic backbones). Examples of sulfonated hydrocarbon block copolymers include poly(styrene-b-[ethylene-co-butylene]-b-styrene) (S-SEBS), poly(styrene-b-isobutylene-b-styrene) (S-SIBS), polystyrene-b-poly(ethylene-alt-propylene) (PS-PEP), poly(styrene-b-methyl butene) (PSS-b-PMB), poly(styrene-b-methyl methacrylate) (PSS-b-PMMA), poly([norbornenyleneethylstyrene-r-styrene]-b-styrenesulfonic) (PNS-b-PSSA), poly(hexyl methacrylate)-b-poly(styrene)-b-poly (hexyl methacrylate) (PHMA-b-PS-b-PHMA). One particular example of a sulfonated block copolymer is Nexar™, a sulfonated hydrocarbon pentablock terpolymer. Zwitterion layer 104 is in the form of a second polymer including a zwitterionic component, and bonded to the first polymer (e.g., to a single side of the first polymer). Examples of zwitterionic components include [2-(methacryloyloxy)ethyl]dimethyl-(3-sulfopropyl) ammonium hydroxide (DMAPS) and 2-methacryloyloxyethyl phosphorylcholine (MPC). Suitable second polymers include diacrylates (e.g., poly(ethylene glycol) diacrylate).

Pervaporation membranes are coated with zwitterions using a solvent-free copolymerization method in which a photoinitiator is used to initiate a free radical polymerization reaction between polymerization precursors. As described herein, making a zwitterion coated membrane includes coating a polymerizable material on a substrate, and polymerizing the polymerizable material, thereby bonding a second polymer to the substrate. As described with respect to FIG. 1, the substrate includes the first polymer, and the polymerizable material includes the zwitterionic component. Bonding the second polymer to the substrate typically includes forming a layer of the polymerizable material on a single side of the substrate.

In one example, the membrane is produced from Nexar™ polymer, the zwitterion is [2-(methacryloyloxy)ethyl]dimethyl-(3-sulfopropyl) ammonium hydroxide (DMAPS), the polymer used in the copolymerization reaction is poly(ethylene glycol) diacrylate 500 Mn (PEDGA), and the radical photoinitiator is 2-hydroxy-2-methylpropiophenone (HOMPP). A solution of PEGDA and DMAPS is prepared by adding the DMAPS powder to the PEGDA liquid. The HOMPP is added to this solution and the mixture is poured onto the Nexar™ membrane and cast under darkness. The polymerization precursors are cured using UV radiation to produce the zwitterion coated membrane. The Nexar™ membrane can be made by forming a solution of Nexar™ polymer in a solvent and casting the solution onto a MYLAR sheet.

### Examples

Materials. Kraton Polymers LLC, Houston, TX, USA provided Nexar™ polymer, in a solvent mixture of cyclohexane and heptane, with an ion exchange capacity (IEC) of 2.0 meq g⁻¹. Commercial MYLAR sheets (poly(ethylene terephthalate) (PET)) type F-50043 were obtained from the Griff Network for casting. Toluene, n-propanol, tetrahydrofuran (THF), hydroxyethylmethacrylate (HEMA), dimethyl sulfoxide (DMSO), azobisisobutyronitrile (AIBN), poly(ethylene glycol) diacrylate 500 Mₙ (PEGDA), [2-(methacryloyloxy)-ethyl]dimethyl-(3-sulfopropyl) ammonium hydroxide (DMAPS), 2,2-dimethoxy-2-phenylacetophenone (DMPA), 2-hydroxy-2-methylpropiophenone (HOMPP), sodium chloride, ammonium bicarbonate, potassium sulfate, monopotassium phosphate, magnesium chloride, and calcium chloride were obtained from Sigma Aldrich. DRIERITE™ gypsum desiccant with indicator was obtained from Drierite.com.

Nexar™ membrane preparation. Solutions of 20 wt % Nexar™ in 50/50 wt % n-propanol/toluene were prepared and cast with a doctor blade at a height of 400 μm on a MYLAR sheet. When these membranes were coated with zwitterions as described below, they did not rupture in the cross-flow pervaporation system.

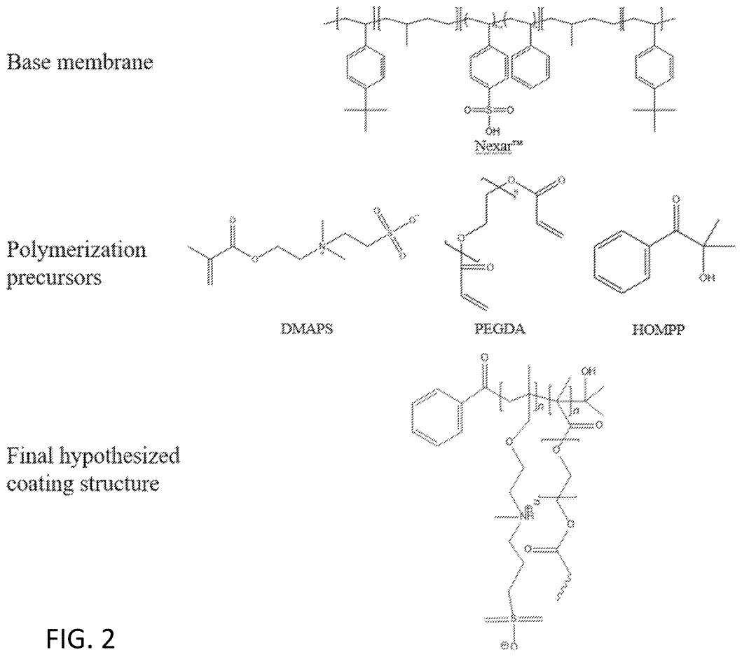

Zwitterion coating method. Several copolymerization methods were tested for incorporating the zwitterion [2-(methacryloyloxy)ethyl]dimethyl-(3-sulfopropyl) ammonium hydroxide (DMAPS) onto the surface of the Nexar™ membranes. A solvent-free method is described in which a reaction is initiated between [2-(methacryloyloxy)ethyl]dimethyl-(3-sulfopropyl) ammonium hydroxide (DMAPS) and poly(ethylene glycol) diacrylate 500 Mn (PEDGA) using radical photoinitiator, 2-hydroxy-2-methylpropiophenone (HOMPP). FIG. 2 shows the chemical structure of these four macromolecules and a theoretical final structure of the coating polymer. Nexar™ is the base polymer layer and unchanged throughout the process. DMAPS is the zwitterion of interest, PEGDA serves as a monomer to accomplish copolymerization with, and HOMPP is the UV activated free radical initiator. The resulting structure is depicted in FIG. 1. PEGDA, the polymer used in the co-polymerization reaction, is in the liquid state at standard conditions and has two double carbon bonds, which serve as a site for free radical initiated polymerization. DMAPS, the zwitterion, is in the solid state and also has a double carbon bond. The double carbon bonds provide sites where free radical initiation occurs. To prepare the zwitterion coating on the Nexar™ membranes, a batch of 15 grams of solution containing 50 mol % PEGDA and 50 mol % DMAPS was prepared. The DMAPS powder was added to the PEGDA liquid in a scintillation vial and stirred at 3000 rpm for 1 hour at room temperature. HOMPP was added (as an initiator) to the scintillation vial for a target of 3.7 mol %. The vial was wrapped in foil to prevent ambient light from inducing photoinitiation and the solution was stirred for 1 hour at room temperature. Approximately 3 mL of the PEGDA/DMAPS/HOMPP solution was poured onto the Nexar™ membrane and cast with the doctor blade at a height of 200 μm. The Nexar™ membrane coated with PEGDA/DMAPS/HOMPP was placed in the UV chamber to cure for 10 minutes at a distance of 3 inches from the light source (36 W and 365 nm). After curing the coated membranes were removed from the MYLAR sheet for testing.

For membrane coupons tested in a pervaporation cross-flow system, zwitterions were coated onto one side of the membrane. For membrane coupons tested in the passive scaling batch tests the zwitterions were coated onto both sides of the membranes to obtain a uniform surface for monitoring scalant deposition.

Membrane post-treatment methods. The membranes were sonicated in deionized (DI) water and tested for excess monomer removal. The membranes were sonicated for 15 minutes in 100 mL of ultrapure DI water. The water was decanted from the tube, and the DI water rinsing was repeated three times. This procedure was done for both as-cast Nexar™ membranes and Nexar™ membranes coated with zwitterions. After sonication washing of the membranes, the membranes were placed in a desiccator vacuum jar to dry and store until use. Four general types of membranes were prepared, as summarized in Table 1.

TABLE 1
Membrane sample types including casting and treatment variables

| Sample ID | Sample description | Coating | Sonication |
|---|---|---|---|
| UN | Nexar ™ untreated | None | No |
| SN | Nexar ™ sonicated | None | Yes |
| UZ | Zwitterion untreated | Zwitterion copolymer | No |
| SZ | Zwitterion sonicated | Zwitterion copolymer | Yes |

Attenuated Total Reflectance Fourier Transform Infrared (ATR-FTIR) spectroscopy. ATR-FTIR measurements were made using a Nicolet 6700 FTIR machine with a Smart Orbit diamond ATR attachment, taking thirty-two scans per sample. This analysis was performed on membrane sample types (Nexar™ sonicated (SN) and Nexar™ zwitterion coated sonicated (SZ).

DI water contact angles were measured using a Kruss Easy Drop contact angle goniometer in sessile drop mode. Ten drops per sample were measured for both Nexar™ untreated (UN) and Nexar™ zwitterion coated (UZ) sample types, with both the highest and lowest measurements removed from analysis for each type. Contact angle measurements were not performed on sonicated samples, SN and SZ, because the membranes would not lie flat on the goniometer plate.

A Soxhlet extraction analysis was performed to analyze the extent of polymerization of the unsupported zwitterion polymer. Free-standing zwitterion layers made as described previously without the base Nexar™ membrane. The extraction process was run for 24 hours in THF and the samples were dried in a vacuum oven at ambient temperature post extraction. Initial and final weights of the polymers were measured in order to determine the gel fraction (extent of polymerization) experienced by the polymer. Gel fraction is calculated according to Eq. (1):

$$G = ( \frac{{W}_{fin}}{{W}_{init}} ) * 100 \qquad ( 1 )$$

where G is the gel fraction and is unitless, often expressed as a percentage. The terms Wᵢₙᵢₜ and W_{fin} represent the initial and final weights of the polymer sample, respectively.

Pervaporation flux experiments. Pervaporation flux experiments were performed using a custom-built cross flow cell with a membrane active area of 5 cm by 5 cm, a recirculating feed, a vacuum level of ~10⁻⁴ torr, and a liquid nitrogen cold trap to capture the permeate. The membranes were placed into the pervaporation cross-flow cell and performed leak tests were performed (consisting of circulating water and draining twice) for 30 minutes with DI water and high vacuum (~10⁻⁴ torr). If no leaks were detected, the feed water was changed to a 32 g L⁻¹ sodium chloride solution and the system was operated under the high vacuum for 30 minutes to achieve steady state operation. After the initial equilibration time, the permeate was collected for 30 minutes and its mass was analyzed using gravimetric analysis. The conductivity of the permeate was measured using an EDAQ (Colorado Springs, CO) USB isoPod EPU357 conductivity meter to calculate the salt removal value.

Membrane flux, permeance, and salt removal were calculated from the raw data collected (time, mass, conductivity). Flux is defined herein as the passage of water through the membrane over a given time normalized by the area of the membrane and given by Eq. 2:

$${J}_{water} = \frac{m}{A Δ t} \qquad ( 2 )$$

where J_{water} (kg m⁻² hr⁻¹) is the flux, m (kg) is the mass of water collected, A (m²) is the active area of the membrane, and Δt (hr) is the time over which the mass was collected. Permeance, F_{water} (kg m⁻² hr⁻¹ bar⁻¹), is the flux normalized by the difference in vapor pressures between the feed and permeate sides of the membrane. Permeance, given by Eq. 3, facilitates comparisons across membranes of different materials tested at variable operating conditions:

$${F}_{water} = \frac{m}{A Δ t Δ {p}^{sat}} \qquad ( 3 )$$

where Δp^{sat} (bar) is the difference in vapor pressure between the permeate and feed sides of the membrane and A, m, and Δt are as described for Eq. 2. Permeability, P_{water} (kg m m⁻² hr⁻¹ bar⁻¹), given in Eq. 4, is related to permeance, but also normalizes for the thickness of a membrane in the system to allow comparisons across different membrane types:

$${P}_{water} = \frac{ml}{A Δ t Δ {p}^{sat}} \qquad ( 4 )$$

where all variables are as defined above, and l(m) is the membrane thickness. Finally, salt removal given by Eq. 5 is the measure of the efficacy of a given separation:

$${R}_{salt} = ( 1 - \frac{{c}_{perm}}{{c}_{feed}} ) \qquad ( 5 )$$

where Rₛₐₗₜ is the salt removal value and is unitless, often expressed as a percentage. The terms cₚₑᵣₘ and c_{feed} (g L⁻¹) represent, respectively, the salt concentrations in the permeate and feed streams. Calibration curves were generated using standardized solutions prior to each conductivity measurement in order to ensure accurate readings.

Passive scaling test protocol. Passive scaling studies were performed on the membranes in static, batch solutions. Membranes were placed in scaling solutions and used gravimetric analysis was used to quantify the mass of scalant deposited on the membranes over a one-week period. Table 2 shows the synthetic scaling solutions of individual scalants of interest to NASA that were made at room temperature in DI water and used for these studies. Scalant solutions were made at the respective solubility limit for each species as measured at 20° C.

TABLE 2
Scalant solution concentrations

| Scalant name | Chemical formula | Concentration (g L⁻¹) |
|---|---|---|
| Ammonium | NH₅CO₃ | 217 |
| bicarbonate | | |
| Sodium chloride | NaCl | 359 |
| Potassium sulfate | K₂SO₄ | 111 |
| Monopotassium | KH₂PO₄ | 226 |
| phosphate | | |
| Magnesium chloride | MgCl₂ | 546 |
| Calcium chloride | CaCl₂ | 754 |

For the scaling experiments, 70 mL of each scalant solution was placed into a plastic 100 mL jar with a lid with a single membrane coupon (~2.5 cm×7 cm) and allowed it to sit, sealed for one week at room temperature. Triplicate experiments were performed for of each type of coated and uncoated membrane. After removal from the solution, the membranes were placed in a desiccant vacuum sealed chamber until dry. Once dry, measured the final membrane mass was measured, and calculated the percent weight change of the membranes was calculated.

To produce a homogeneous sample, coated membranes had coatings on both sides of the membrane, although this is not typically necessary for pervaporation system implementation. This allowed the samples to free-float in the scaling solution without exposing both Nexar™ and zwitterion coated sides of the membrane to the scalants. In system implementation, it is typically only needed for the feed side of the membrane to be coated as that is the only side in contact with scalants.

ATR-FTIR analysis of Nexar™ structure. The results of the ATR-FTIR performed on the Nexar™ polymer before and after sonication steps revealed no chemical structure changes take place. When sonicating the membrane prior to passive scalant studies, it is advantageous to include a desiccation step to be able to accurately take the weight of the membrane prior to submersion in the scalant solution. This wetting/drying cycle does change the microstructure, leading to significant mechanical changes. While Nexar™ in its freshly cast state is flexible and facile to handle, the wet-dry cycling experienced during the sonication/desiccation process yields a brittle membrane that breaks very easily. This change in microstructure and mechanical properties makes the sonicated Nexar™ membrane unsuitable for use in a system.

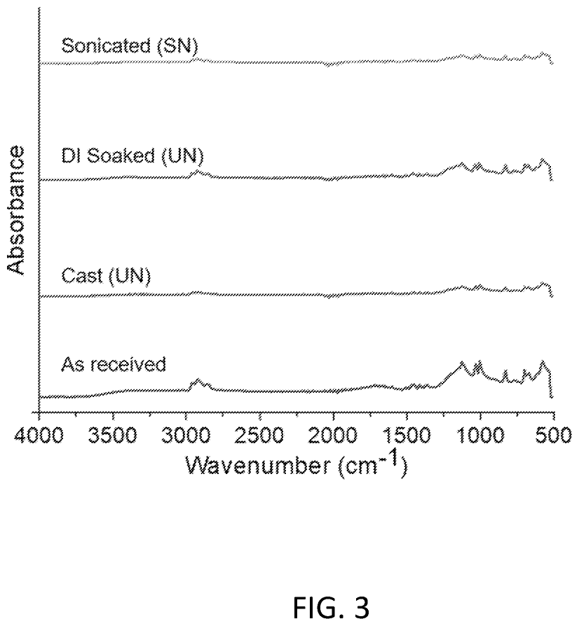

To further probe the changes seen after sonicating the membranes, the bond structure of membranes was analyzed in various states of processing. FIG. 3 shows the ATR-FTIR spectra for the dried, as received Nexar™ polymer and the cast membranes. The as-received polymer arrives in a solution of cyclohexane and heptane. The polymer is dried in order to remove the hydrocarbons. The UN cast membrane is an un-sonicated Nexar™ membrane after casting. DI soaked and sonicated membranes are processed as mentioned above. While there is a difference in intensity in the peaks across all samples, there are no bond shifts or changes indicating that sonication does not change the chemical bonding of the Nexar™ membranes. Differences in intensity suggest that differing amounts of materials are present in each sample and/or poor contact with the machine.

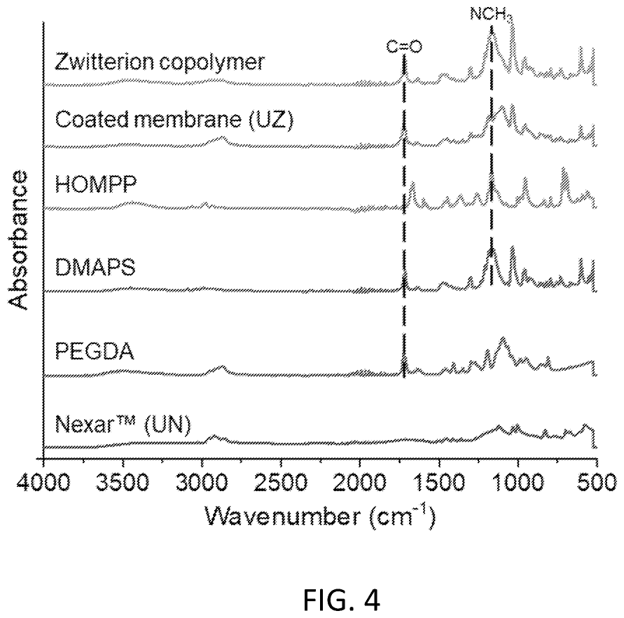

ATR-FTIR analysis of membrane coating procedure. When performing the polymerization procedure on the surface of the membranes, the PEGDA acts as the solvent for the DMAPS; as a solvent-free process, this minimized the potential dissolution or swelling of Nexar™ (which occurs in certain solvents, e.g., n-propanol, toluene, heptane, cyclohexane, water, etc.). HOMPP, the polymerization initiator, is also liquid. This solvent free process can provide a fast polymerization reaction. FIG. 4 shows the ATR-FTIR spectra of the polymer components and coated membrane. The representative peaks marked on the graph present in polymerization precursors and the final coated membrane indicate that the desired polymerization reaction occurred and that the zwitterion copolymer is present on the surface of the membrane. In the component materials the C—O peak is present at 1720 cm⁻¹ in PEGDA, 1664 cm⁻¹ in HOMPP, and 1714 cm⁻¹ in DMAPS. There is no C═O functionality in Nexar™. Therefore, the peak at 1722 cm⁻¹ on the UZ (Nexar™ coated with zwitterion), as well as the zwitterion copolymer with no Nexar™ base, indicates that the zwitterion polymerization was successful. The final polymerized coating C—O peak appears at 1722 cm⁻¹, which is shifted higher than the three individual polymerization components, suggests that desired polymerization took place because of the appearance C═O bonds in the final coated membrane structure that are not present in the base Nexar™ membrane. Additionally, the NCH₃ at 1163 cm⁻¹ in DMAPS, 1169 cm⁻¹ in HOMPP, and very strongly at 1161 cm⁻¹ in the final coating structure further support desired zwitterion polymerization. This peak is somewhat spread out in the spectra for the sample with the coating on the base Nexar™, likely due to the hydrogen bonding both within the polymer matrix and between the coating and the base membranes. FIG. 2 shows the hypothesized final structure of the zwitterion coating. The shifting of the absorbance of carbonyl in the final structure (1722 cm⁻¹) suggests some stretching, potentially because the final structure may experience overlapping stresses within the polymer matrix. Polymerization is random, therefore there are many possible configurations of the final copolymer structure. For example, the HOMPP initiator splits into two free radicals when exposed to UV light, so either one of those molecules could serve to initiate or terminate the molecule. While the DMAPS and PEGDA were mixed in equimolar ratios, it is difficult for the structure to perfectly alternate the molecules, hence the brackets are used in FIG. 2 that can denote different amounts of each molecule. Some polymerization occurs from the second carbon double bond in the PEGDA molecule, indicated by a waved line in the figure, therefore creating a non-linear polymer structure.

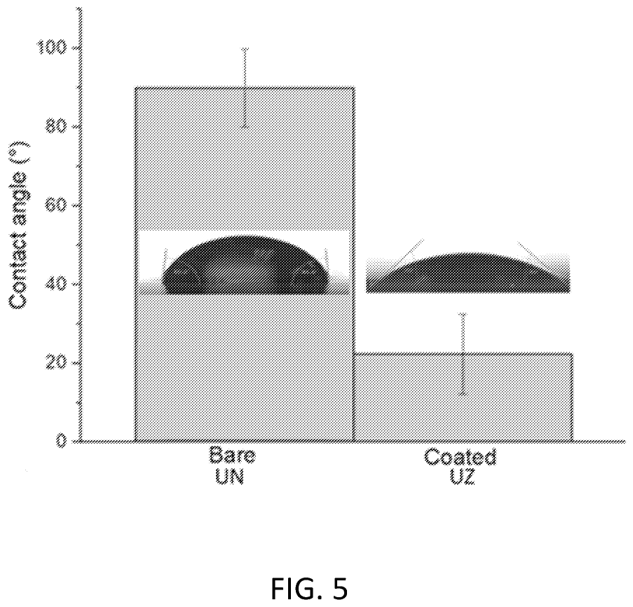

Contact angle analysis. FIG. 5 shows the average contact angles and representative images for the UN and UZ membranes. The coated membrane shows an increase in hydrophilicity correlating with a decrease in contact angle. The average contact angle for the UN membranes (bare Nexar™ membranes) was 89.9°±9.9°, which was larger than the average contact angle for UZ membranes (zwitterion coated), which was 22.3°±10.1°. The zwitterion coating reduces the DI water contact angle of the membrane surface, indicating that the zwitterion functionality is present on the membrane and is inducing relative hydrophilicity. Since scaling at the membrane surface is a primary concern in system scaling, surface interactions are of significant importance. Increased relative hydrophilicity is theorized to assist in enhancing anti-scaling properties.

The analysis of Soxhlet extraction revealed a gel fraction of the polymer of 94.7%+1.5%. This indicates that the polymerization took place as desired and created the polymer matrix between the DMAPS, PEGDA, and HOMPP constituents, in alignment with the ATR-FTIR results. A gel fraction of >90% is considered desirable in order to obtain well polymerized samples with minimal leftover constituents.

Pervaporation flux and desalination experiments. Table 3 shows the cross-flow pervaporation desalination tests of membrane performance. The bare Nexar™ membranes (UN) had a permeance of 122.1 kg m⁻² hr⁻¹ bar⁻¹±5.1 kg m⁻² hr⁻¹ bar⁻¹ and the coated membranes (UZ) had a permeance value of 63.9 kg m⁻² hr⁻¹ bar⁻¹±8.7 kg m⁻² hr⁻¹ bar⁻¹. Under a one-way Analysis of Variance (ANOVA) statistical test (with an alpha value of 0.05 and a Tukey Means Comparison) the difference in permeance between the Nexar™ membranes, regardless of casting method, was not statistically significant.

The UZ (zwitterion coated membranes) have a permeance that is 53% less than the UN membrane. Both membranes experience high amounts of salt removal, approaching 100% with error values on the order of 10⁻³. Under a one-way ANOVA with an alpha value of 0.05 and Tukey means comparison test, the salt removal values are not statistically different from each other. The permeance (water transport property) is lower for the UZ membrane compared to the UN membrane. The addition of zwitterions into the polymer structure of membranes increases water transport properties when integrated into the polymer structure of membranes during initial casting. The UZ membrane is a zwitterion co-polymer coating on the surface of the base Nexar™ membrane (not integrated into the Nexar™ polymer during the initial casting). Since the zwitterions are added to the membrane surface via a polymerization reaction that also introduces other polymer species (HOMPP and PEGDA), the increased thickness of the membrane overall increases the transport resistance for the combination membrane. The permeability observed in Table 3 is consistent with these observations, as that is the combined permeability of both the base membrane and the coating. The coating is too brittle to be run independently, thus the composite membrane is the primary sample for analysis.

TABLE 3
Membrane thickness, permeance, and permeability
for various membrane sample types

| | | Permeance | Permeability |
|---|---|---|---|
| | Membrane | (kg m⁻² hr⁻¹ | (kg m m⁻² hr⁻¹ |
| Sample type | thickness (μm) | bar⁻¹) | bar⁻¹) |
| Thomas et al. | 52 | 135.5 ± 29 | 7.1 · 10⁻³ ± 1.5 |
| 2020 | | | |
| Bare Nexar ™ | 100 ± 14 | 122.1 ± 5.1 | 1.2 · 10⁻¹ ± 1.4 · 10⁻¹ |
| (UN) | | | |
| Zwitterion | 280 ± 140 | 63.9 ± 8.7 | 1.8 · 10⁻² ± 5.1 · 10⁻¹ |
| coated (UZ) | | | |

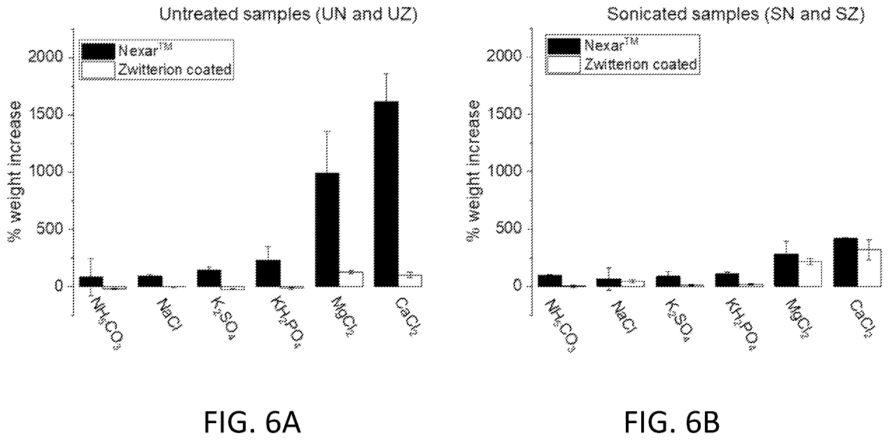

Scaling studies. FIGS. 6A and 6B show scaling studies for both bare Nexar™ membranes and zwitterion coated membranes during passive 7-day experiments, with the membranes desiccated prior to final weights measurement. All scalant solutions are at their respective solubility limits in de-ionized water at 20° C., with pH values in the 2.5-3.0 range. FIG. 6A shows test results of the passive scaling studies for the six individual scaling solutions described in Table 2 for the unsonicated bare Nexar™ (UN) membranes and the zwitterion coated membranes (UZ). For all scalants, the UZ membranes have less mass gain at the end of the experiment than the UN, indicating less scalant deposited on the membrane surface. However, for four of the scalant solutions (ammonium bicarbonate, sodium chloride, potassium sulfate, and monopotassium phosphate), the observed membrane mass decreased during the passive scaling test time, with the largest membrane mass loss occurring in the sodium chloride samples at a level of −31.25%±2.54%. This could result at least in part from: 1) the low pH of the scaling solution degraded the membranes, 2) unreacted polymer from the coating process diffused out of the membrane during the week-long soaking, and/or 3) absorption of ambient moisture into the membranes during initial gravimetric analysis that is then removed in the later desiccation step. Sonication of the as-synthesized membranes yielded the greatest amount of mass loss across all membrane samples, and therefore this step was integrated into the subsequent studies. The mass loss in the actual studies is similar to what is observed in these membrane tests, which were also in the range of −30%. While sonication may somewhat degrade bonded polymers, the continued presence of the coating on the surface and the anti-scaling behavior still present meant that the coating is still active on the surface. Sonication is a facile step to integrate and “clean” the membranes prior to testing and therefore it was implemented to get a consistent baseline for testing.

FIG. 6B shows the results for the SN and SZ membranes after sonication and pre-scaling experiment removal of unreacted monomers. The zwitterion coated membranes (SZ) had less scaling deposition on their surfaces than the uncoated membranes (UN). For scaling studies that lack the sonication step, the bare Nexar™ membranes showed a high amount of scaling behavior, with weight percent increases on the order of 2,000%. When sonicated, the coated membranes show weight percent increases consistently lower than 450%. When comparing the sonicated bare Nexar™ membranes to the sonicated zwitterion coated membranes, however, there is not a statistically significant difference in their scaling behavior; the sonicated bare Nexar™ (SN) membranes have weight percent increases like those in the sonicated zwitterion coated membranes. It is possible the sonication step impacted the structure of the Nexar™ polymer.

The SN membranes showed the smallest mass gain in the scaling studies; however, sonicated membranes may not be practical for pervaporation membrane use. This is because the sonication step in the SN membranes yielded brittle membranes that are unsuitable for use—these membranes cannot be manually handled and placed into the cross-flow pervaporation system without crumbling.

While the UN membranes provide excellent separation and flux values, the highest amount of scalant deposition was observed in the passive scaling studies. The zwitterion coated membranes are the most attractive option for applications. The permeance values of the UZ membranes are less than the UN membranes, which results from the extra coating in the UZ membranes that adds transport resistance. However, the reduction in scaling deposition in the UZ membranes is an excellent quality that has potential to enable longer term operation of the membranes. In the spaceflight applications of interest, a system balance between the speed of separation, the membrane lifetime, and the extent of recovery is advantageous. While the added resistance to transport will lower the speed of a given separation, the longer lifetime and excellent separation properties will minimize resource use in these scenarios. Therefore, the combination of anti-scaling properties as well as mechanical stability provided by the zwitterion coatings on the Nexar™ membranes makes them advantageous for filtration applications. While the sonication step (SZ) is typically necessary for the gravimetric analysis of the scaling behavior of the membranes, sonication is not typically necessary for the system integration of the membrane, as seen in the separation studies. Therefore, UZ is the most facile to produce and viable in system integration.

Embodiments. Although the disclosed inventive concepts include those defined in the attached claims, it should be understood that the inventive concepts can also be defined in accordance with the following embodiments.
Embodiment 1 is a zwitterionic material comprising:
a substrate comprising a first polymer; and
a second polymer bonded to the first polymer, wherein the second polymer comprises a zwitterionic component.
Embodiment 2 is the zwitterionic material of embodiment 1, wherein the first polymer comprises a sulfonated block polymer.
Embodiment 3 is the zwitterionic material of embodiment 1 or 2, wherein the substrate is in the form of a membrane.
Embodiment 4 is the zwitterionic material of embodiment 3, wherein the membrane comprises ordered microstructures.
Embodiment 5 is the zwitterionic material of embodiment 3 or 4, wherein the membrane is a pervaporation membrane.
Embodiment 6 is the zwitterionic material of any one of embodiments 3-5, wherein the second polymer is in the form of a layer on a single side of the membrane.
Embodiment 7 is the zwitterionic material of any one of embodiments 3-6, wherein the second polymer is in the form of a layer on two sides of the membrane.
Embodiment 8 is the zwitterionic material of any one of embodiments 1-7, wherein the zwitterionic component comprises [2-(methacryloyloxy)ethyl]dimethyl-(3-sulfopropyl) ammonium hydroxide (DMAPS).
Embodiment 9 is the zwitterionic material of any one of embodiments 1-8, wherein the second polymer comprises a diacrylate component.
Embodiment 10 is the zwitterionic material of embodiment 9, wherein the diacrylate component comprises poly(ethylene glycol) diacrylate.
Embodiment 11 is a method of making a zwitterionic material, comprising:
coating a polymerizable material on a substrate, wherein the substrate comprises a first polymer and the polymerizable material comprises a zwitterionic component; and
polymerizing the polymerizable material, thereby bonding a second polymer to the substrate, wherein the second polymer comprises the zwitterionic component.
Embodiment 12 is the method of embodiment 11, wherein the first polymer comprises a sulfonated block polymer.
Embodiment 13 is the method of embodiment 11 or 12, wherein the substrate is in the form of a membrane.
Embodiment 14 is the method of embodiment 13, wherein the membrane comprises ordered microstructures.
Embodiment 15 is the method of embodiment 13 or 14, wherein the membrane is a pervaporation membrane.
Embodiment 16 is the method of any one of embodiments 11-15, wherein bonding the second polymer to the substrate comprises forming a layer on a single side of the substrate.
Embodiment 17 is the method of any one of embodiments 11-15, wherein bonding the second polymer to the substrate comprises forming a layer on a two sides of the substrate.
Embodiment 18 is the method of any one of embodiments 11-17, wherein the zwitterionic component comprises [2-(methacryloyloxy)ethyl]dimethyl-(3-sulfopropyl) ammonium hydroxide (DMAPS).
Embodiment 19 is the method of any one of embodiments 11-18, wherein the second polymer comprises a diacrylate component.
Embodiment 20 is the method of embodiment 19, wherein the diacrylate component comprises poly(ethylene glycol) diacrylate.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood asrequiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A zwitterionic material comprising:
a substrate comprising a first polymer; and
a second polymer bonded to the first polymer, wherein the second polymer comprises a zwitterionic component.

2. The material of claim 1, wherein the first polymer comprises a sulfonated block polymer.

3. The material of claim 1, wherein the substrate is in the form of a membrane.

4. The material of claim 3, wherein the membrane comprises ordered microstructures.

5. The material of claim 3, wherein the membrane is a pervaporation membrane.

6. The material of claim 3, wherein the second polymer is in the form of a layer on a single side of the membrane.

7. The material of claim 3, wherein the second polymer is in the form of a layer on two sides of the membrane.

8. The material of claim 1, wherein the zwitterionic component comprises [2-(methacryloyloxy)ethyl]dimethyl-(3-sulfopropyl) ammonium hydroxide (DMAPS).

9. The material of claim 1, wherein the second polymer comprises a diacrylate component.

10. The material of claim 9, wherein the diacrylate component comprises poly(ethylene glycol) diacrylate.

11. A method of making a zwitterionic material, the method comprising:
coating a polymerizable material on a substrate, wherein the substrate comprises a first polymer and the polymerizable material comprises a zwitterionic component; and
polymerizing the polymerizable material, thereby bonding a second polymer to the substrate, wherein the second polymer comprises the zwitterionic component.

12. The method of claim 11, wherein the first polymer comprises a sulfonated block polymer.

13. The method of claim 11, wherein the substrate is in the form of a membrane.

14. The method of claim 13, wherein the membrane comprises ordered microstructures.

15. The method of claim 13, wherein the membrane is a pervaporation membrane.

16. The method of claim 11, wherein bonding the second polymer to the substrate comprises forming a layer on a single side of the substrate.

17. The method of claim 11, wherein bonding the second polymer to the substrate comprises forming a layer on two sides of the substrate.

18. The method of claim 11, wherein the zwitterionic component comprises [2-(methacryloyloxy)ethyl]dimethyl-(3-sulfopropyl) ammonium hydroxide (DMAPS).

19. The method of claim 11, wherein the second polymer comprises a diacrylate component.

20. The method of claim 19, wherein the diacrylate component comprises poly(ethylene glycol) diacrylate.
